(19) United States
(12) Patent Application Publication
(10) Pub. No.: US 2005/0244019 A1
(43) Pub. Date: Nov. 3, 2005

(54) Method and apparatus to improve the reproduction of music content

(75) Inventor: Jean-Christophe Lallemand, Leuven (BE)

Correspondence Address: PHILIPS INTELLECTUAL PROPERTY & STANDARDS, P.O. BOX 3001, BRIARCLIFF MANOR, NY, 10510, US

(73) Assignee: koninklijke phillips electronics nv.

(21) Appl. No.: 10/523,430

(22) PCT Filed: Jul. 21, 2003
(86) PCT No.: PCT/IB03/03295

§ 371 Date: Jan. 28, 2005

(30) Foreign Application Priority Data
Aug. 2, 2002 (EP) 02078170.4

(51) Int. Cl. H04B 15/00

(52) U.S. Cl. 381/94.3

(57) ABSTRACT

In a method for eliminating voice signals from a stereo input signal stream a monophonic and a stereophonic signal stream is derived by adding (3) and subtracting, (4) respectively, the left and right signal content of the stereo input signal stream, where after the monophonic signal stream is filtered by means of a band stop filter device (5), and a stereo output signal stream is obtained by adding (6) the stereophonic signal stream and the filtered monophonic signal stream, and subtracting (7) the stereophonic signal stream and the filtered monophonic signal stream, respectively. The method may be applied for voice suppression in karaoke applications.

The invention relates to a method for eliminating voice signals from a stereo input signal stream by means of a band stop filter device. Such a method may be applied in any digital or analog audio device where karaoke is an interesting feature, like TV's, DVD players, misi-sets, etc.

The human voice bandwidth ranges from about 300 Hz to 4 kHz. This, however, is only an approximation as every human voice is different. When a voice has to be removed from music, the voice can be cancelled so that only the high frequencies and the sub contents of the original music pass the filter. Such a method is known from Japanese publication JP-A-4271700. In this known method discrimination between left and right input signals is maintained, while the human voice signal is excluded from the sound signal components to generate music for Karaoke with maintenance the stereophonic feeling. The disadvantage is that the above frequency band is also suppressed for the music.

The purpose of the invention is to avoid or at least to diminish such a disadvantage and to provide for a voice removal filter which, applied in an audio apparatus, results in relatively low-cost product while the music reproduction is strongly improved.

Therefore, according to the invention, the method for eliminating voice signals as described in the opening paragraph is characterized that from the stereo input signal stream a monophonic and a stereophonic signal stream is derived by adding and subtracting, respectively, the left and right signal content of the stereo input signal stream, the monophonic signal stream is filtered by means of said band stop filter device, and a stereo output signal stream is obtained by adding the stereophonic signal stream and the filtered monophonic signal stream, and subtracting the stereophonic signal stream and the filtered monophonic signal stream, respectively.

The invention does not only relate to a method for eliminating voice signals, but also to a voice suppression filter device for eliminating voice signals from a stereo input signal stream by means of a band stop filter device, in which voice suppression filter device the above method is applied. Therefore this voice suppression filter device is characterized in that a first adding and a first subtracting device are provided to derive from the stereo input signal stream a monophonic and a stereophonic signal stream by adding and subtracting, respectively, the left and right signal content of the stereo input signal stream, the monophonic signal stream being filtered by means of said band stop filter device, and a second adding an a second subtracting device to obtain a stereo output signal stream by adding the stereophonic signal stream and the filtered monophonic signal stream, and subtracting the stereophonic signal stream and the filtered monophonic signal stream, respectively.

In a first improvement parallel to the band stop filter device a low pass filter device is provided, the upper side of the frequency band thereof being adjacent to the lower side of the frequency band of the band stop filter device. In a second improvement a downscaling device is provided to protect the band stop filter device against overflow, while in a third improvement a scaling device is provided to obtain an asymmetry between the channels for the monophonic and the stereophonic signal stream.

The invention further relates to an algorithm for processing a stereo input signal stream applied in the above method and/or applied in the above voice suppression filter device.

The invention also relates to an audio apparatus, provided with the above voice suppression filter, to a computer program capable of running on signal processing means in the above audio apparatus or cooperating with said audio apparatus, and to an information carrier, carrying instructions to be executed by said signal processing means, the instructions being such as to enable said signal processing means to perform the above method.

The invention will be apparent from and elucidated with reference to the example as described in the following and to the accompanying drawing.

In this drawing

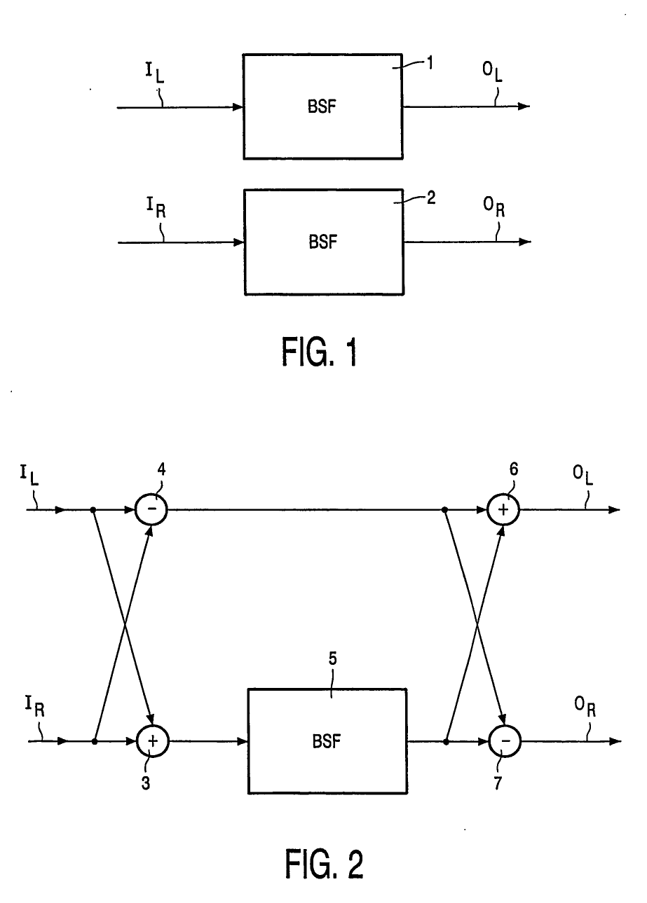

FIG. 1 shows a prior art voice removing filter device;

FIG. 2 shows a basic voice removing filter device according to the invention;

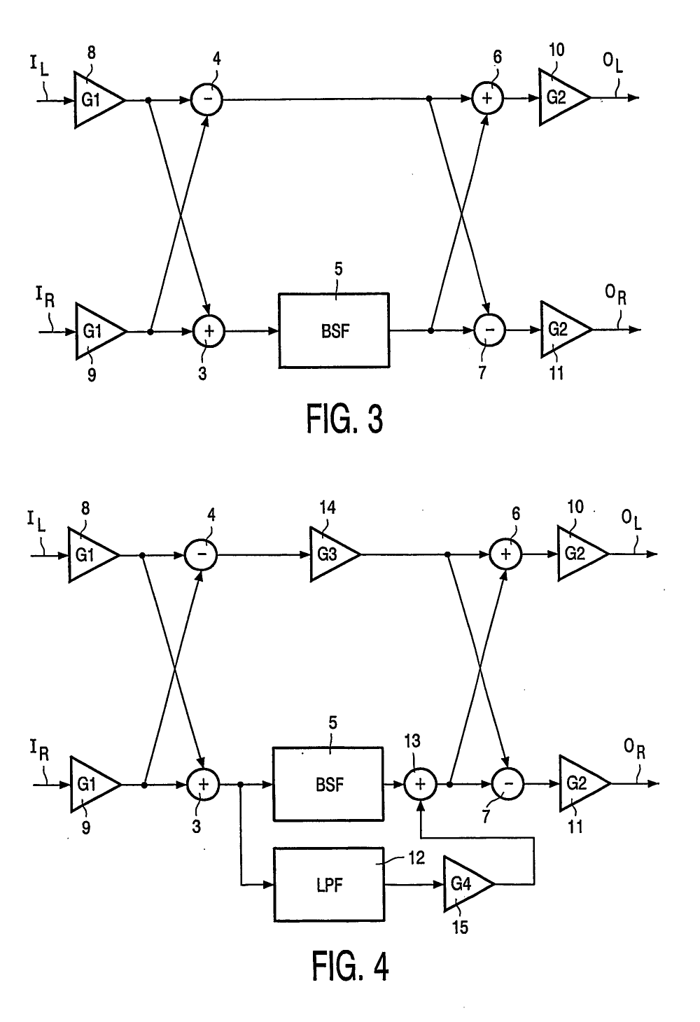

FIG. 3 shows an improved voice removing filter device according to the invention; and

FIG. 4 shows a further improved voice removing filter device.

The prior art voice removing filter device of FIG. 1 shows band stop filters 1 and 2 for voice suppression of left and right input signals. The band stop filter 1 and 2 suppress voice frequencies in the range of 300 Hz to 4 kHz; this is an approximation of the voice bandwidth of a human being. However, this voice removing filter suppresses also music in said frequency band; which is considered as a great disadvantage.

To illustrate the invention a stage with a live band may be taken in mind. For example, at the left there is a piano, in the middle a drummer and on right backing vocals. These positions in the stereo field may be imitated during studio recordings. The lead vocal, that has to be removed, is situated in the middle of the stereo field. If a subtraction is made of the stereo channel content, lead vocals will be removed but musical components mixed out of the stereo center will remain. By adding the content of the two channels all sound information is kept, while after voice filtering all music information mixed out of the stereo center is kept on mono basis. By adding and subtracting the stereo component back to the filtered music the stereo information is got back. The result of this implementation, which is indicated in FIG. 2, sounds a lot better than is the case by applying the prior art vocal filtering.

The basic voice removing filter of FIG. 2 comprises first adding and subtracting devices 3 and 4 respectively, a band stop filter 5 and second adding and subtracting devices 6 and 7 respectively. By means of the adding device 3 the left and right input signals are added to form a monophonic signal, while by means of the subtracting device 4 these input signals from these input signals a stereophonic signal is obtained. The monophonic signal is filtered by the 300 Hz to 4 kHz band stop filter 5. By means of the adding device 6 the stereophonic signal and the filtered monophonic signal are added to each other, while by means of the subtracting device 7 the filtered monophonic signal and the stereophonic signal are subtracted from each other. The output signals of the adding and the subtracting device 6 and 7 form the stereo output signals, wherein the voice is suppressed, but the music quality is strongly maintained.

Another further advantage of this implementation is that backing vocals are not erased. Usually, these are stereo mixed. This gives an open sound without interfering with the lead vocal. In some music two backing vocal recordings are made. One is made for the left and another is made for the right stereo field. It gives the impression that there are more singers. All these voices are perfectly recovered by the present implementation.

Unfortunately not every instrument is mixed out of stereo center. In the embodiment of FIG. 2 bass guitar, bass drum and snare drums are always mono mixed because they are the basis of the music. The sub frequencies, lower than 300 Hz, of the bass drum and bass guitar are recovered but higher frequencies are lost. This translates into loss of sound definition. In other words: you will still feel bass but you would not hear the clean lines and guitar slaps anymore. With the snare drum the situation is much worse. The sound will be almost completely lost. This disadvantage could be diminished by a downscaling process. A downscaling factor G1 is added to protect the filter against overflow. This factor is compensated by a factor G2 at the end of the process. The insertion of a downscaling factor is indicated in the improved embodiment of FIG. 3. This embodiment is very near to that of FIG. 2; the difference is that downscaling devices 8 and 9 in inserted in the left and right input channels, while compensating devices 10 and 11 are inserted in the left and right output channels.

The downscaling factor G1 is the same for both channels because of the following subtraction. If not, the lead vocal would not be removed. The rescaling factor G2 is in fact only a master volume. By doing so two advantages were obtained. The sound is much more dynamic because of bigger difference between the left and right channel. The sound quality was much closer to the original then it had ever been before. We also get less remaining voice because the stereo factor is made more important than the mono factor. However, there is still a less important disadvantage: the sub-frequencies are also discriminated. Therefore, in a further improvement embodiment an additional low-pass filter with cut off frequency of 300 Hz is inserted to enhance the bass sub-layer. This further improved embodiment is indicated in FIG. 4, which is very near to that of FIG. 3; the difference is that an additional low pass filter device 12 with a bandwidth from 0 to 300 Hz is inserted parallel to the band stop filter 5, while a further adding device 13 and scaling devices 14 and 15 are inserted. By the insertion of a scaling factor G3 by means of the scaling device 14 in the stereophonic channel an asymmetry is brought into the voice removing filter which allows getting an enhanced stereo impression when sound is reproduced. Moreover, since the monophonic content is downscaled compared to the stereophonic content, the remaining part of the voice which would not be rejected by the filter will sound softer than in the embodiment of FIG. 3.

The embodiments described above may be realized by an algorithm, at least part of which may be in the form of a computer program capable of running on signal processing means in an audio apparatus comprising the above voice removing filter. In so fat part of the figures show units to perform certain programmable functions, these units can be considered as subparts of the computer program.

The invention is not restricted to the described embodiments; modifications within the scope of the following claims are possible.

1. Method for eliminating voice signals from a stereo input signal stream by means of a band stop filter device, characterized in that from the stereo input signal stream a monophonic and a stereophonic signal stream is derived by adding and subtracting, respectively, the left and right signal content of the stereo input signal stream, the monophonic signal stream is filtered by means of said band stop filter device, and a stereo output signal stream is obtained by adding the stereophonic signal stream and the filtered monophonic signal stream, and subtracting the stereophonic signal stream and the filtered monophonic signal stream, respectively.

2. Voice suppression filter device for eliminating voice signals from a stereo input signal stream by means of a band stop filter device, characterized in that a first adding and a first subtracting device are provided to derive from the stereo input signal stream a monophonic and a stereophonic signal stream by adding and subtracting, respectively, the left and right signal content of the stereo input signal stream, the monophonic signal stream being filtered by means of said band stop filter device, and a second adding an a second subtracting device to obtain a stereo output signal stream by adding the stereophonic signal stream and the filtered monophonic signal stream, and subtracting the stereophonic signal stream and the filtered monophonic signal stream, respectively.

3. Voice suppression filter device according to claim 2, characterized in that parallel to the band stop filter device a low pass filter device is provided, the upper side of the frequency band thereof being adjacent to the lower side of the frequency band of the band stop filter device.

4. Voice suppression filter device according to claim 2 or 3, characterized in that a downscaling device is provided to protect the band stop filter device against overflow.

5. Voice suppression filter device according to claim 3, characterized in that a gain element is provided to obtain an asymmetry between the channels for the monophonic and the stereophonic signal stream.

6. Algorithm for processing a stereo input signal stream applied in the method of claim 2 and/or applied in the voice suppression filter device of any one of the claims 2-5.

7. Audio apparatus, provided with the voice suppression filter according to any one of the claims 2-5.

8. Computer program capable of running on signal processing means in an audio apparatus or cooperating with an audio apparatus comprising the voice suppression filter device according to claim 7.

9. Information carrier, carrying instructions to be executed by signal processing means, the instructions being such as to enable said signal processing means to perform the method according to claim 1.
